(19) United States
(12) Patent Application Publication
(10) Pub. No.: US 2025/0381519 A1
(43) Pub. Date: Dec. 18, 2025

(54) CO2 CONCENTRATOR AND RELATED MATERIALS, PROCESSES, AND SYSTEMS

(71) Applicant: SUSTEON INC., Morrisville, NC (US)

(72) Inventors: Monica Abdallah, Raleigh, NC (US); Emma Cook, Raleigh, NC (US); Raghubir Gupta, Durham, NC (US); Jian-Ping Shen, Chapel Hill, NC (US); Arnold Toppo, Raleigh, NC (US); Shaojun James Zhou, Cary, NC (US); Andrew Tong, Raleigh, NC (US)

(21) Appl. No.: 19/238,440

(22) Filed: Jun. 14, 2025

Related U.S. Application Data
(60) Provisional application No. 63/660,291, filed on Jun. 14, 2024.

(51) Int. Cl. B01D 53/62; B01D 53/04; B01D 53/96

(52) U.S. Cl. CPC B01D 53/62; B01D 53/0462; B01D 53/96; B01D 2253/202; B01D 2253/304; B01D 2253/306; B01D 2253/308; B01D 2253/311; B01D 2253/34; B01D 2257/504

(57) ABSTRACT

A process is described for concentrating CO₂ from feed gases containing CO₂ at concentrations up to 1 vol % (10,000 ppmv) to produce product gas containing CO₂ at concentration that is at least twice the concentration of CO₂ in the feed gas, wherein the concentration of CO₂ in the product gas does not exceed 20 vol %. The process may be carried out in a CO₂ concentrator including one or more structured sorbent elements, in which the sorbent includes (i) a mesoporous and macroporous polymer backbone, (ii) CO₂ adsorbing agent, and (iii) an additive effective to enhance CO₂ adsorption, enhance CO₂ desorption, lower the regeneration temperature of the sorbent, and/or enhance the thermal and/or oxidative stability of the sorbent. The structured sorbent elements may be arranged for Joule heating to regenerate the CO₂ adsorbing agent with sweep gas at low temperature, e.g., in a range of from 50° C. to 150° C.

### CROSS-REFERENCE TO RELATED APPLICATION

The benefit of U.S. Provisional Patent Application 63/660,291 filed Jun. 14, 2024 in the names of Shaojun James Zhou, Jian Ping Shen, Raghubir Prasad Gupta, Aravind Rabindran, and Arnold Toppo for CO₂ CONCENTRATOR AND RELATED MATERIALS, PROCESSES, AND SYSTEMS is hereby claimed under the provisions of 35 USC § 119, and the disclosure of U.S. Provisional Patent Application 63/660,291 is hereby incorporated herein by reference, in its entirety, for all purposes.

### STATEMENT OF FEDERALLY FUNDED RESEARCH

This invention was made with Government support under DE-FE0032254 awarded by the United States Department of Energy. The Government has certain rights in this invention.

### FIELD

The present disclosure relates to CO₂ concentration processes, and CO₂ concentrators and related materials and systems, which are useful to concentrate CO₂ from feed gases containing CO₂ at concentrations up to 1 vol % (10,000 parts-per-million by volume (ppmv)) to produce product gas containing CO₂ at concentration that is at least twice the concentration of CO₂ in the feed gas, wherein the concentration of CO₂ in the product gas does not exceed 20 vol %.

### DESCRIPTION OF RELATED ART

Carbon dioxide (CO₂) is generated from various sources, including metabolic processes, resource mining and refining, fuel combustion, oxidation reactions, and wildfire events.

CO₂ is currently the focus of much climatological attention associated with its greenhouse gas character, and a wide variety of CO₂ technologies are evolving to address the abatement, capture, and sequestration of CO₂. Most of these efforts are directed to or rely on recovering CO₂ at high purity (90-100 vol %) from gas streams and environments where CO₂ is present. The high purity CO₂ recovery systems and processes utilized for such efforts generally involve apparatus and processes with large capital equipment and operating expenses, and high energy requirements, which utilize chemical agents and materials that substantially deteriorate in performance and utility over time.

The present disclosure takes a different approach. There are existing technologies that efficiently capture CO₂ from CO₂ streams (e.g., 4-20 vol %) generated by industry. Atmospheric CO₂ capture and purification continues to challenge scientists and engineers due to kinetic and thermodynamic obstacles well understood and reported in the literature.

### SUMMARY

The present disclosure relates to CO₂ concentration processes, and CO₂ concentrators and related materials and systems, which are useful to concentrate CO₂ from gases containing CO₂ at concentrations up to 1 vol % (10,000 ppmv) to produce product gas containing CO₂ at concentration that is at least twice the concentration of CO₂ in the feed gas, and wherein the concentration of CO₂ in the product gas does not exceed 20 vol %.

The disclosure thus relates in one aspect to a process for concentrating CO₂ from feed gases containing CO₂ at concentrations up to 1 vol % (10,000 ppmv) to produce product gas containing CO₂ at concentration that is at least twice the concentration of CO₂ in the feed gas, and wherein the concentration of CO₂ in the product gas does not exceed 20 vol %.

In another aspect, the disclosure relates to a process for concentrating CO₂ from feed gas containing CO₂ at concentration in a range of from 0.05 vol % (500 ppmv) to 1 vol % (10,000 ppmv) to produce product gas containing CO₂ at concentration that is at least twice the concentration of CO₂ in the feed gas, and wherein the concentration of CO₂ in the product gas is in a range of from 0.1 vol % (1000 ppmv) to 20 vol % (200,000 ppmv).

In a further aspect, the disclosure relates to a process for concentrating CO₂ from feed gas containing CO₂ at concentration up to 1 vol % to produce product gas containing CO₂ at concentration that is at least twice the concentration of CO₂ in the feed gas, and wherein the concentration of CO₂ in the product gas does not exceed 20 vol %, comprising: (a) contacting the feed gas, e.g., ambient air, containing CO₂ at concentration up to 10,000 parts-per-million by volume (ppmv) with sorbent on a gas-permeable media, the sorbent comprising (i) a porous support, e.g., a mesoporous and macroporous polymer backbone with a pore size greater than 5 nm, (ii) CO₂ adsorbing agent that is covalently bound to or otherwise attached to the polymer backbone, and (iii) an additive effective to enhance CO₂ adsorption, enhance CO₂ desorption, lower the regeneration temperature of the sorbent, and/or enhance the thermal and/or oxidative stability, wherein the contacting is conducted at temperature in a range of from −30° C. to 50° C., and wherein the contacting comprises flowing the feed gas through the media so that CO₂ is selectively adsorbed by the sorbent to produce CO₂-reduced gas as effluent from the contacting; (b) terminating the contacting of step (a); and (c) flowing regeneration gas, e.g., ambient air, through the media while heating the sorbent to temperature in a range of from 50° C. to 150° C. as the regeneration temperature, to desorb CO₂ from the sorbent to produce the product gas containing CO₂ at concentration that is at least twice the concentration of CO₂ in the feed gas, and wherein the concentration of CO₂ in the product gas does not exceed 20 vol %.

In another aspect, the disclosure relates to a CO₂ concentration process as described above, which is performed to provide CO₂-containing product gas to a CO₂-utilizing process system or facility, wherein the CO₂-utilizing process system or facility is selected from the group consisting of: a point source CO₂ capture process system; a membrane separation CO₂ production process system; a carbon mineralization process system; a greenhouse facility; and an aquaculture facility for algae or other aquatic plants or organisms.

The disclosure relates in another aspect to a CO₂ concentrator module, comprising sorbent comprising (i) a porous support, e.g., a mesoporous and macroporous polymer backbone with a pore size greater than 5 nm, (ii) CO₂ adsorbing agent that is covalently bound to or otherwise attached to the porous support, e.g., and (iii) an additive effective to enhance CO₂ adsorption, enhance CO₂ desorption, lower the regeneration temperature of the sorbent, and/or enhance the thermal and/or oxidative stability, wherein the sorbent is comprised in multiple structured sorbent elements. Such CO₂ concentrator modules may be provided in a variety of designs, configurations, and arrangements, as hereinafter more fully described, such as arranged in the following formats: (a) stand-alone, (b) in series, (c) staggered, (d) in parallel, (e) in parallel and series, (f) pleated, and (g) pleated in series, or modules comprising the sorbent in sheet form or laminate structures.

Another aspect of the disclosure relates to a CO₂ concentrator process system comprising multiple ones of the above-described CO₂ concentrator module, constructed and arranged for performance of a CO₂ concentration process.

In a further aspect, the disclosure relates to structured sorbents for concentrating CO₂, in which the structured sorbent is heated for CO₂ desorption, by any of a variety of heating modalities, such as conduction, convection, or radiative heating, or electrically resistive/Joule heating.

A further aspect of the disclosure relates to a structured sorbent comprising sorbent comprising (i) a porous support, e.g., a mesoporous and macroporous polymer backbone with a pore size greater than 5 nm, (ii) CO₂ adsorbing agent that is covalently bound to or otherwise attached to the porous support, and (iii) an additive effective to enhance CO₂ adsorption, enhance CO₂ desorption, lower the regeneration temperature of the sorbent, and/or enhance the thermal and/or oxidative stability.

A still further aspect of the disclosure relates to a media comprising sorbent comprising (i) a porous support, e.g., a mesoporous and macroporous polymer backbone with a pore size greater than 5 nm, (ii) CO₂ adsorbing agent that is covalently bound to or otherwise attached to the support, and (iii) an additive effective to enhance CO₂ adsorption, enhance CO₂ desorption, lower the regeneration temperature of the sorbent, and/or enhance the thermal and/or oxidative stability.

A still further aspect of the disclosure relates integration of the CO₂ concentrator module, or CO₂ concentrator process system, with various downstream processes that can use the concentrated CO₂ fluid (containing CO₂ at concentration up to 20 vol %) as a utility, including for example point source capture systems for high purity, >90%, CO₂ production, ex-situ mineralization, use in the food/beverage industry, greenhouse farming, and algae cultivation.

Yet another aspect of the disclosure relates to a CO₂ concentration process of the disclosure, as performed to provide CO₂-containing product gas to a CO₂-utilizing process system or facility, wherein the CO₂-utilizing process system or facility produces an effluent gas, and the effluent gas is recirculated to constitute at least part of the regeneration gas in the CO₂ concentration process.

The disclosure relates in further aspect to a CO₂ sorbent composition, comprising (i) a porous support, e.g., a mesoporous and macroporous polymer backbone with a pore size greater than 5 nm, (ii) CO₂ adsorbing agent that is covalently bound to or otherwise attached to the porous support, and (iii) an additive effective to enhance CO₂ adsorption, enhance CO₂ desorption, lower the regeneration temperature of the sorbent, and/or enhance the thermal and/or oxidative stability of the sorbent.

Additional aspects, features and embodiments of the disclosure will be more fully apparent from the ensuing description and appended claims.

### BRIEF DESCRIPTION OF THE DRAWINGS

FIG. 1 is a schematic description of a sorbent of the present disclosure.

FIG. 2 shows the structure of a preferred sorbent composition of the present disclosure.

FIG. 3 depicts concentrator modules arranged in series, in top plan view (a) and perspective view (b), wherein the effluent of module 1 flows into module 2 during the adsorption step, and wherein a fan is used to draw air through the modules.

FIG. 4 shows (a) a top plan view of CO₂ concentrator modules arranged in parallel around a central fan and (b) a top plan view of CO₂ concentrator modules arranged in a pleated configuration around a fan array.

FIG. 5 in (a) shows CO₂ concentrator modules arranged in parallel and in series with a single fan used for driving ambient air through them. Two modules in series can be isolated and undergo a separate step in parallel with other modules. FIG. 7 in (b) shows modules arranged in series and in parallel with multiple fans for adsorption and/or desorption.

FIG. 6 illustrates isolation movements using a cylindrical coordinate system: (a) depicts a CO₂ concentrator module with round butterfly isolation valves in the open position so that gas can flow through freely and CO₂ can be adsorbed; (b) depicts a CO₂ concentrator module with round butterfly isolation valves in the closed position so that gas flow is blocked and concentrated CO₂ can be collected; (c) depicts a CO₂ concentrator module with rectangular isolation dampers in the open position so that gas can flow through freely and CO₂ can be adsorbed; and (d) depicts a CO₂ concentrator module with rectangular isolation dampers in the closed position so that gas flow is blocked and concentrated CO₂ can be collected.

FIG. 7 illustrates isolation movements using a linear coordinate system: (a) depicts a CO₂ concentrator module with guillotine isolation dampers in the raised position so that gas can flow through freely and CO₂ can be adsorbed; and (b) depicts a CO₂ concentrator module with guillotine isolation dampers in the lowered position so that gas flow is blocked and concentrated CO₂ can be collected.

FIG. 8 shows examples of integration of structured sorbents with indirect heating fluids in the adsorption and desorption states while a sweep gas is used to facilitate desorption, where in the left portion of the drawing, adsorption gas flows through a set of channels or between plates/fins which remove CO₂ from the gas stream, and where in the right portion of the drawing, desorption sweep gas flows through a set of channels or between plates/fins while a heating fluid is passed through tubes or channels so that heat is transferred to the sorbent and concentrated CO₂ is produced.

FIG. 9 illustrates a mobile sorbent module that passes through an adsorption section and a desorption section in the assembly unit, which has requisite fluid drivers and heating mechanisms for facilitating the process sequence steps.

FIG. 10 is a schematic representation of a CO₂ concentrator process system according to one embodiment of the present disclosure, including a series of CO₂ concentrator modules arranged for continuous production of product gas containing CO₂ at concentration that is at least twice the concentration of CO₂ in the feed gas, and wherein the concentration of CO₂ in the product gas does not exceed 20 vol %.

FIG. 11 is a schematic representation of an alternative CO₂ concentrator process system according to another embodiment of the present disclosure, including a series of CO₂ concentrator modules arranged for continuous production of product gas containing CO₂ at concentration that is at least twice the concentration of CO₂ in the feed gas, and wherein the concentration of CO₂ in the product gas does not exceed 20 vol %.

FIG. 12 is a schematic representation of an alternative CO₂ concentrator process system according to another embodiment of the present disclosure, including a series of CO₂ concentrator modules arranged for continuous production of product gas containing CO₂ at concentration that is at least twice the concentration of CO₂ in the feed gas, and wherein the concentration of CO₂ in the product gas does not exceed 20 vol %.

FIG. 13 is a process flow diagram of a CO₂ concentrator integrated with a solvent-based point source CO₂ capture process.

FIG. 14 is a process flow diagram of a CO₂ concentrator integrated with a CO₂ membrane separation unit.

FIG. 15 is a process flow diagram of a CO₂ concentrator integrated with ex-situ carbon mineralization.

FIG. 16 is a process flow diagram of a CO₂ concentrator integrated with a greenhouse farm.

FIG. 17 shows the CO₂ adsorbed and desorbed during a six-cycle experiment on macroporous polystyrene cross-linked with divinylbenzene and functionalized with benzylamine with 1,2-epoxybutane CO₂ concentrator sorbent.

FIG. 18 shows the CO₂ capacity (wt %) throughout 500 rapid adsorption/desorption cycles performed continuously on macroporous polystyrene cross-linked with divinylbenzene and functionalized with benzylamine with 1,2-epoxybutane.

FIG. 19 shows a comparison of fresh and aged sample performance of the macroporous polystyrene cross-linked with divinylbenzene and functionalized with benzylamine with 1,2-epoxybutane CO₂ concentrator sorbent using a 70° C. desorption temperature.

FIG. 20 shows the concentration of CO₂ (vol %) as a function of time (minutes) using macroporous polystyrene cross-linked with divinylbenzene and functionalized with benzylamine with 1,2-epoxybutane CO₂ concentrator sorbent in an experiment showing ability to concentrate CO₂ to nearly 8 vol %.

### DETAILED DESCRIPTION

The present disclosure relates to CO₂ concentration processes, and CO₂ concentrators and related materials and systems, which are useful to concentrate CO₂ from gases containing CO₂ at concentrations up to 1 vol % (10,000 parts-per-million by volume (ppmv)) to produce product gas containing CO₂ at concentration that is at least twice the concentration of CO₂ in the feed gas, and wherein the concentration of CO₂ in the product gas does not exceed 20 vol %.

The sorbent composition of the present disclosure, although primarily described herein in reference to concentrating CO₂ from feed gas containing CO₂ at concentration up to 1 vol % (1000 parts-per-million by volume (ppmv)) to produce product gas containing CO₂ at concentration that is at least twice the concentration of CO₂ in the feed gas, and wherein the concentration of CO₂ in the product gas does not exceed 20 vol %, may be utilized in a wide variety of other CO₂ adsorption applications, with general applicability to the processing of CO₂-containing gases.

It will additionally be appreciated that although the integration of the process of the present disclosure with various CO₂-utilizing process systems and facilities is specifically described, the utility of the process of the present disclosure is not thus limited, and the CO₂ adsorption process of the present disclosure may be employed with a wide variety of CO₂-utilizing process systems and facilities to provide gaseous CO₂ thereto, such as in applications for: chemical synthesis of materials; manufacture of plastics, paints, coatings, fertilizers, etc.; food preservation and packaging; acidification of solvents and aqueous media; enhanced growth and yield of plants and microorganisms; enhanced oil recovery; fire suppression; refrigeration; production of biochar; calibration and monitoring of leak detection systems; chromatography carrier fluids; and any other applications in which CO₂ or CO₂-containing gas may be advantageously employed.

The present disclosure in one aspect relates to a process for concentrating CO₂ from feed gas containing CO₂ at concentration up to 1 vol % (10,000 ppmv) to produce product gas containing CO₂ at concentration that is at least twice the concentration of CO₂ in the feed gas, and wherein the concentration of CO₂ in the product gas does not exceed 20 vol % (200,000 ppmv).

In various embodiments, the disclosure relates to a process for concentrating CO₂ from feed gas containing CO₂ at concentration in a range of from 0.05 vol % (500 ppmv) to 1 vol % (10,000 ppmv) to produce product gas containing CO₂ at concentration that is at least twice the concentration of CO₂ in the feed gas, and wherein the concentration of CO₂ in the product gas is in a range of from 0.1 vol % (1000 ppmv) to 20 vol % (200,000 ppmv).

Processes of the present disclosure can be seamlessly integrated with existing point source CO₂ capture processes. Other process integrations include: downstream membrane separation to further concentrate CO₂ for food and beverage applications; introduction of the product gas into greenhouses to enhance photosynthesis through supplementation of CO₂; enhanced oil recovery; cement curing; algae cultivation; and carbon dioxide mineralization, among others.

In another aspect of the disclosure, the CO₂ concentration process of the disclosure may be conducted to provide CO₂-containing product gas to a CO₂-utilizing process system or facility, wherein the CO₂-utilizing process system or facility produces an effluent gas, and the effluent gas is recirculated to constitute at least part of the regeneration gas in the process.

As used herein, the singular forms “a”, “an”, and “the” include plural referents unless the context clearly dictates otherwise.

Although technological and regulatory efforts are focused on CO₂ capture and sequestration from gases with substantial content of CO₂, to achieve highly concentrated product gas compositions containing 90 vol % or more CO₂, point source or local source emissions of CO₂ in gases containing less than 10,000 ppm by volume (ppmv) are vastly more numerous and therefore in the aggregate have a substantial, albeit underrecognized, climatological impact.

Further, the CO₂ capture and sequestration techniques that are applied to substantial CO₂ content gases (>1% CO₂) to achieve highly concentrated product gas compositions containing 90 vol % or more CO₂, cannot be practically or economically utilized to address CO₂ in gases containing less than 10,000 ppmv of CO₂, due to their high capital equipment and operating costs. In this respect, it is to be noted that currently most sorbent-based processes for CO₂ removal from ambient air adsorb water from ambient air and the energy necessary to desorb such water is more than 3 to 15 times that required for CO₂ desorption. The water-to-CO₂ molar ratio in ambient air varies from 10 to 100, depending on the ambient temperature and humidity. Most traditional sorbent supports, like alumina, silica, titania, zeolites, metal organic frameworks (MOFs), or combinations thereof, essentially function as desiccants for adsorbing water from ambient air. This water must be desorbed during the regeneration by providing external energy. The heat of adsorption of water is ˜39 KJ/mol. Assuming that for every mole of CO₂, 3 to 15 moles of water are adsorbed, the heat to desorb such water will be as much as 580 kJ for every mole of CO₂ desorbed. The heat of CO₂ desorption typically varies between 60 KJ/mol to 85 KJ/mol of CO₂. Therefore, the amount of energy needed for desorption of water is almost 10 times that for CO₂, which adds to the significant energy consumption and energy requirement in a DAC process. In addition, current CO₂ sorbents used in DAC contactors rapidly degrade under oxidation and thermal conditions, and current DAC contactor designs are complex and expensive.

The present disclosure avoids such deficiencies, in an underrecognized CO₂ concentration regime, by utilizing a class of sorbents that have low water vapor adsorption capacity and that can be regenerated at low regeneration temperatures, e.g., 70° C. or lower, by sweeping with air or other sweep gas, in a simple and efficient process and physical implementation. Desorption heat requirement can be met by any of a variety of heating modalities and sources, e.g., electrical heating, resistive heating, radio frequency heating, steam, hot air and other gas streams, waste heat sources (e.g., natural gas plants, data centers, chemical refineries), solar heat, geothermal heat, etc., at very low cost. Desorption heat may be generated in situ in the sorbent substrate, or it may be provided externally (ex situ). The terms “desorption” and “regeneration” are used interchangeably herein, with reference to removal of previously adsorbed CO₂ from sorbent to produce product gas containing CO₂ at concentration that is at least twice the concentration of CO₂ in the feed gas, and wherein the concentration of CO₂ in the product gas is in a range of from 0.1 vol % (1000 ppmv) to 20 vol % (200,000 ppmv). Likewise, desorption gas and regeneration gas refer to gas that is employed to remove previously adsorbed CO₂ from sorbent containing such adsorbate.

The CO₂ concentrator process, CO₂ concentrator modules, structured sorbents, media, and substrates of the present disclosure avoid high regeneration energy requirements, utilizing sorbents that in the presence of water or water vapor are adsorptively competitively selective for CO₂ to minimize and substantially eliminate water as a sorbate component, and that are free of micro- and meso-porosity (<5 nm) that otherwise support water capillarity uptake in exposure to gases containing water or water vapor.

The product gas that is produced using the structured sorbent, CO₂ concentrator modules, and CO₂ concentration process of the present disclosure, containing CO₂ at concentration that is at least twice the concentration of CO₂ in the feed gas, and wherein the concentration of CO₂ in the product gas does not exceed 20 vol %, can be utilized for any applications or purposes for which such product gas has utility.

The features and advantages of the CO₂ concentration process of the present disclosure, and the features and advantages of the sorbent aspect of the present disclosure, will be more fully apparent from the ensuing disclosure and the non-limiting examples reflecting particular embodiments and applications of the disclosure.

The CO₂ concentrator process, CO₂ concentrator modules, structured sorbents, media, and substrates of the present disclosure avoid high regeneration energy requirements, utilizing sorbents that in the presence of water or water vapor are adsorptively competitively selective for CO₂ to minimize and substantially eliminate water as a sorbate component, and that are free of micro- and meso-porosity (<5 nm) that otherwise support water capillarity uptake in exposure to gases containing water or water vapor.

The product gas that is produced using the structured sorbent, CO₂ concentrator modules, and CO₂ concentration process of the present disclosure, containing CO₂ at concentration that is at least twice the concentration of CO₂ in the feed gas, and wherein the concentration of CO₂ in the product gas does not exceed 20 vol %, can be utilized for any applications or purposes for which such product gas has utility.

The features and advantages of the CO₂ concentration process of the present disclosure, and the features and advantages of the sorbent aspects of the present disclosure, will be more fully apparent from the ensuing disclosure and the non-limiting examples reflecting particular embodiments and applications of the disclosure.

As used herein, the term “alkyl” includes, but is not limited to, methyl, ethyl, propyl, isopropyl, butyl, s-butyl, t-butyl, pentyl and isopentyl and the like. In various embodiments, alkyl moieties may include C₁-C₁₂ alkyl. “Aryls” as used herein includes hydrocarbons derived from benzene or a benzene derivative that are unsaturated aromatic carbocyclic groups from 6 to 15 carbon atoms. The aryls may have a single or multiple rings. The term “aryl” as used herein also includes substituted aryls. Examples include, but are not limited to phenyl, naphthyl, xylene, phenylethane, substituted phenyl, substituted naphthyl, substituted xylene, substituted phenylethane and the like. “Cycloalkyls” as used herein include, but are not limited to cyclopropyl, cyclobutyl, cyclopentyl, cyclohexyl and the like. As used herein, “alkenyl” includes hydrocarbons containing at least one double bond. Alkenyl moieties include C₂-C₁₂ but are not limited to ethylene, propylene, butylene, pentene, and the like. As used herein, “aminoalkyl” includes alkyl containing at least one amine group. In various embodiments, alkyl moieties of the aminoalkyl may include one, two, or three C₁-C₁₂ alkyl of any combination. Examples include, but are not limited to, methylamine, dimethylamine, trimethylamine, N,N-diethylmethylamine, N-ethylmethylamine and the like. As used herein, “aminoalkanol” includes alkyl containing at least one hydroxyl and amine groups. In various embodiments, alkyl moieties of the aminoalkanol may include one, two or three C₁-C₁₂ alkyl or any combination. Examples include, but are not limited to, monoethanolamine, aminobutanol, aminopropanol, and the like.

In all chemical formulae herein, a range of carbon numbers will be regarded as specifying a sequence of consecutive alternative carbon-containing moieties, including all moieties containing numbers of carbon atoms intermediate the endpoint values of carbon number in the specific range as well as moieties containing numbers of carbon atoms equal to an endpoint value of the specific range, e.g., C₁-C₆, is inclusive of C₁, C₂, C₃, C₄, C₅ and C₆, and each of such broader ranges may be further limitingly specified with reference to carbon numbers within such ranges, as sub-ranges thereof. Thus, for example, the range C₁-C₆ would be inclusive of and can be further limited by specification of sub-ranges such as C₁-C₃, C₁-C₄, C₂-C₆, C₄-C₆, etc. within the scope of the broader range.

Thus, the identification of a carbon number range, e.g., in C₁-C₁₂ alkyl, is intended to include each of the component carbon number moieties within such range, so that each intervening carbon number and any other stated or intervening carbon number value in that stated range, is encompassed, it being further understood that sub-ranges of carbon number within specified carbon number ranges may independently be included in smaller carbon number ranges, within the scope of the disclosure, and that ranges of carbon numbers specifically excluding a carbon number or numbers are included in the invention, and sub-ranges excluding either or both of carbon number limits of specified ranges are also included in the disclosure. Accordingly, C₁-C₁₂ alkyl is intended to include methyl, ethyl, propyl, butyl, pentyl, hexyl, heptyl, octyl, nonyl, decyl, undecyl and dodecyl, including straight chain as well as branched groups of such types. It therefore is to be appreciated that identification of a carbon number range, e.g., C₁-C₁₂, as broadly applicable to a substituent moiety, enables, in specific embodiments of the invention, the carbon number range to be further restricted, as a sub-group of moieties having a carbon number range within the broader specification of the substituent moiety. By way of example, the carbon number range e.g., C₁-C₁₂ alkyl, may be more restrictively specified, in particular embodiments of the disclosure, to encompass sub-ranges such as C₁-C₄ alkyl, C₂-C₈ alkyl, C₂-C₄ alkyl, C₃-C₅ alkyl, or any other sub-range within the broad carbon number range. In other words, a carbon number range is deemed to affirmatively set forth each of the carbon number species in the range, as to the substituent, moiety, or compound to which such range applies, as a selection group from which specific ones of the members of the selection group may be selected, either as a sequential carbon number sub-range, or as specific carbon number species within such selection group.

The disclosure, as variously set out herein in respect of features, aspects and embodiments thereof, may be constituted as comprising, consisting, or consisting essentially of, some or all of such features, aspects and embodiments, and particular elements and components thereof may be aggregated to constitute various further implementations of the disclosure. The disclosure is set out herein in various embodiments, and with reference to various features and aspects of the disclosure. The disclosure contemplates such features, aspects and embodiments in various permutations and combinations, as being within the scope of the disclosure. The disclosure may therefore be specified as comprising, consisting or consisting essentially of, any of such combinations and permutations of these specific features, aspects and embodiments, or a selected one or ones thereof.

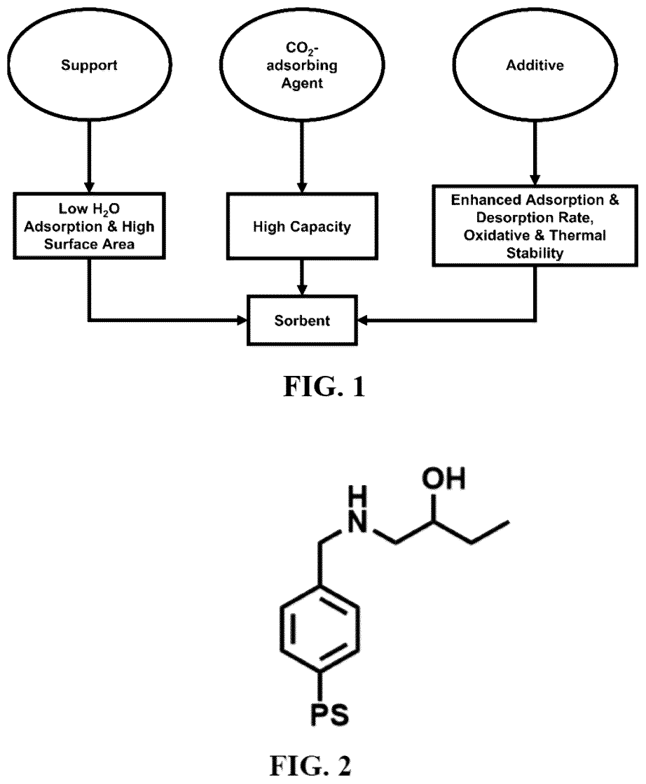

As used herein, the term “sorbent” is defined as comprising (i) a porous support, (ii) CO₂ adsorbing agent that is covalently bound to or otherwise attached to such support, and (iii) an additive effective to enhance CO₂ adsorption, enhance CO₂ desorption, lower the regeneration temperature of the sorbent, and/or enhance the thermal and/or oxidative stability. The sorbent is schematically described in FIG. 1. The CO₂ adsorbing agent in the sorbent may be of any suitable type and may for example comprise one or more than one amine, amino acid, or carbonate species, or mixtures of two or more of such species or species types in. Likewise, the additive may comprise one or more than one additive species.

The support, also known as the sorbent backbone, may advantageously comprise a solid mesoporous (e.g., >5 nm pore size) and/or macroporous polymer and/or inorganic support. In various embodiments, the support may comprise a backbone of a mesoporous and macroporous polymer, wherein mesoporosity is constituted by pores of from 2 to 50 nm in size, preferably pores greater than 5 nm and up to 50 nm in size, and wherein macroporosity is constituted by pores greater than 50 nm in size. In various embodiments, the support may comprise a hydrophobic polymer structure where CO₂ capture sites are located. Optimal porosity minimizes diffusion resistance and allows CO₂ containing air to access active sites, while the hydrophobicity of the polymer works to curtail the amount of water adsorption during the process. Polymers with hydrophobic character that can be made into a macroporous particle can be used in this process. Some examples include polystyrene (PS), polyvinylidene fluoride (PVDF), polyacrylonitrile (PAN), polytetrafluoroethylene (PTFE), polypropylene (PP), polyethylene (PE), polyvinylchloride (PVC), polydimethylsiloxane (PDMS), polyacrylates, polyesters, polyurethanes, polyimides, polysilanes, polysulfides, polythiazyls, polysiloxanes, and polyphosphazenes. In certain embodiments, the polymer backbone is polystyrene. In other embodiments, the support may comprise hydrophilic polymers, and may for example include polymers, e.g., polyacrylonitrile (PAN), polyesters, and polyurethanes, that are tunable to provide hydrophilic properties. The polymers can contain various crosslinkers, including divinylbenzene (DVB) and dicumyl peroxide (DCP).

In various embodiments, porous inorganic materials, such as silica, alumina, ceria, zirconia, and aluminates, can be used as support materials.

With respect to presence of water vapor in the CO₂-containing gas that is contacted with the CO₂-adsorbing sorbent in the process of the present disclosure, the sorbent may include a support, such as for example a mesoporous and macroporous polymer backbone, with a pore size greater than 5 nm, and such support may be of hydrophobic character, so that such hydrophobicity and pore size of greater than 5 nm together ensure that competitive adsorption of CO₂ and water greatly favors CO₂ and minimizes the presence of water in the adsorbate. Such minimization of water in the adsorbate in turn reduces the overall energy requirement for desorption, since the amount of energy needed for desorption of water is almost 10 times that for CO₂, as discussed in the description herein. As previously mentioned, ambient air that is utilized in the CO₂ concentration process may be dehumidified prior to its introduction to the CO₂ concentration process, and other water vapor control and elimination techniques may be employed in the broad practice of the present disclosure, if and to the extent necessary or desirable.

In certain embodiments, the CO₂ adsorbing agent may comprise an amine that selectively adsorbs CO₂ via chemisorption or physisorption and can desorb captured CO₂ at moderate regeneration temperatures (see below). The amines used herein can be primary, secondary, or tertiary amines with the general chemical formula, R₁R₂NR₃, where R₁, R₂, and R₃ are independently, hydrogen, alkyl, alkenyl, aminoalkyl, aminoalkanol, cycloalkyl, aryl, or other hydrocarbon moieties and can be polymer materials. The CO₂ adsorbing agent can be immobilized on the support/mesoporous and macroporous backbone via grafting, covalent bonding or impregnation to achieve a loading of 0.5 to 35 wt % of nitrogen, based on weight of the support.

In the process of the present disclosure, the CO₂-adsorbing agent may comprise an amine of the formula R₁—NH₂, R₁NHR₂, or R₁NR₂R₃, where R₁, R₂ and R₃ are each independently alkyl, alkenyl, aminoalkyl, aminoalkanol, cycloalkyl, aryl, or other hydrocarbon moieties, e.g., in which the alkyl is C₁-C₈ alkyl, in which the alkenyl is C₂-C₈ alkenyl, in which the cycloalkyl is C₃-C₈ cycloalkyl, or in which the aryl is C₆-C₁₂ aryl.

In various embodiments, the CO₂-adsorbing agent comprises an amine of the formula —NH₂, —R₁NH, or —R₁NR₂, wherein R₁ and R₂ and are each independently a substituent with carbon number of C₁-C₈. For example, R₁ and R₂ may each be independently selected from the group consisting of alkyl, aryl, aminoalkyl, aminoalkanol, cycloalkyl, and arylalkyl.

In other embodiments, the CO₂-adsorbing agent may comprise one or more than one amine selected from the group consisting of poly(ethyleneimine), poly(propylenimine), poly(allylamine), tetraethylenepentamine, monoethanolamine, benzylamine, triethanolamine, dimethanolamine, diethylenetriamine, 2-2 (-aminoethylamino) ethanol, diisopropanolamine, 2-amino-2-methyl-1,3-propanediol, pentaethylenehexamine, tetramethylenepentaamine, methyldiethanolamine, aminomethyl propanol piperazine and piperazine derivatives, piperidine and piperidine derivatives, and pyrrolidine and pyrrolidine derivatives.

In other embodiments, amino acids may also serve as the active CO₂-adsorbing agent, which include alanine, asparagine, aspartic acid, cysteine, glutamic acid, glutamine, glycine, histidine, isoleucine, leucine, lysine, methionine, phenylalanine, proline, serine, taurine, threonine, tryptophan, tyrosine, valine. The alkali salts of these amino acids may also be considered the CO₂ adsorbing, including potassium and sodium salts.

In certain embodiments, one or multiple additives may be added to the sorbent and serve to enhance the CO₂ adsorption and/or desorption kinetics, lower the regeneration temperature, and/or enhance the thermal and/or oxidative stability of the sorbent. In addition, additives may be used to boost hydrophobicity character of the sorbent to further minimize water uptake during the process

In certain embodiments the additive may be comprised of alkali carbonate salts, including sodium carbonate and potassium carbonate.

In various embodiments, the additive may comprise a compound of the formula R₁R₂N—R₃—COOH, wherein each of R₁, R₂ and R₃ is independently selected from H, C₁-C₁₂ alkyl, C₁-C₁₂ alkoxy, C₁-C₁₂ carboxy, C₁-C₁₂ haloalkyl, C₆-C₁₂ aryl, C₆-C₁₄ arylalkyl, C₅-C₁₀ cycloalkyl, amino, substituted amino, thiol, phosphate, sulfate, phosphonate, and sulfonate. In specific embodiments, each of R₁, R₂ and R₃ may be independently selected from H and C₁-C₁₂ alkyl.

In other embodiments, amino acids may serve as an additive in the active sorbent including alanine, asparagine, aspartic acid, cysteine, glutamic acid, glutamine, glycine, histidine, isoleucine, leucine, lysine, methionine, phenylalanine, proline, serine, taurine, threonine, tryptophan, tyrosine, and valine.

In certain embodiments, the additive can consist of epoxy-derivatives, e.g., at least one selected from the group consisting of alkyl-epoxy (i.e. epoxybutane, epoxypropane), glycidol and its derivatives, and 1,2-epoxy-2-methylpropane.

In other embodiments, the additive can be a chelating agent, e.g., comprising at least one selected from the group consisting of ammonium ([R₁R₂NR₃R₄]⁺) and alkali phosphate salts, where R₁, R₂, R₃ and R₄ are independently hydrogen, alkyl, alkenyl, aminoalkyl, aminoalkanol, cycloalkyl, aryl, or other hydrocarbon (hydrocarbyl) moieties. Some examples include trisodium phosphate, lithium phosphate, tetraethyl ammonium phosphate, and tetramethylammonium phosphate.

In various embodiments hydroxyl containing polymers can act as additives in the sorbent described. Examples include polyethylene glycol, hydroxyethylene starch, cellulose, and polyvinyl alcohol. Phenol, amine and sulfur-based antioxidants can also be additives. Some examples include 2,6-di-tert-butyl-p-cresol, (4-(1-methyl-1-phylethyl)N-[4-(1-methyl-1-phenylethyl)phenyl] alanine), and 2-mercaptobenzimidazole.

In certain embodiments, when the CO₂ adsorbing agent contains a secondary amine, it can serve as both the CO₂ adsorbing agent and as an additive. In certain embodiments, CO₂ adsorbing agent with additive functionality can comprise piperazine, dimethylpiperazine, or aminoethylpiperazine, or any combination of two or more thereof. Thus, the disclosure in various embodiments contemplates the sorbent as comprising a secondary amine as at least a part of the CO₂ adsorbing agent and as at least a part of the additive. In particular embodiments, the sorbent may comprise piperazine, dimethylpiperazine, or aminoethylpiperazine, or any combination of two or more thereof, as at least a part of the CO₂ adsorbing agent and as at least a part of the additive. In a specific implementation, the sorbent may comprise piperazine, dimethylpiperazine, or aminoethylpiperazine, or any combination of two or more thereof, as the CO₂ adsorbing agent and as the additive, on a mesoporous and/or macroporous polystyrene support, as a sorbent composition that is effective to reduce thermal oxidative degradation while providing effective CO₂ concentration performance.

The additive can be immobilized on the sorbent by covalent bonding, attaching it to either the support (e.g., mesoporous and/or macroporous polymer backbone), CO₂ capture agent, or another additive. The additive can be dispersed into the support before or after the introduction of the CO₂ active agent or before or after the addition of an additive. Additives can be comprised of one or more of the aforementioned examples and types.

In various embodiments, the additives in this process are alkyl-epoxy derivatives, specifically 1,2-epoxybutane. The additive can be in a 0.1 to 1 molar ratio relative to the CO₂ adsorbing agent.

The sorbent utilized in the process of the present disclosure, in various embodiments, may be provided in a spherical particulate form, having a particle size in a range from 0.01 mm to 5.0 mm, or more preferably, in a range from 0.1 to 2 mm, and having pore size of porosity in a range of from 5 nm to 500 nm, or from 5 nm to 200 nm, or from 5 nm to 100 nm, or most preferably from 5 nm to 50 nm, and the pore volume of the sorbent particles may be in a range of from 0.1 cm³/gram to 3 cm³/gram, and more preferably from 0.1 cm³/gram to 1.5 cm³/gram, although the disclosure is not limited thereto, and other particle sizes, pore sizes, and pore volumes may be employed. The sorbent may have a BET surface area in a range of 10 m²/gram to 500 m²/gram in various embodiments, and in other embodiments may have a BET surface area in a range of 10 m²/gram to 150 m²/gram.

Thus, the sorbent may be provided in a spherical particulate form, with a particle size in a range from 0.01 mm to 5.0 mm, a pore size of porosity in a range of from 5 nm to 500 nm, a pore volume of sorbent particles in a range of from 0.1 cm³/gram to 3 cm³/gram, and a BET surface area in a range of 10 m²/gram to 500 m²/gram.

In various embodiments, the sorbent is prepared by synthetically modifying a mesoporous and/or macroporous polymer backbone to incorporate the CO₂ adsorbing agent. Then, the additive is incorporated via amine substitution of alkyl epoxy derivatives, with a preferred molar ratio of 0.5 relative to the active amine. In one preferred embodiment, the sorbent comprises benzylamine substituted macroporous polystyrene beads, modified with 0.5 molar equivalents of 1,2-epoxybutane additive (FIG. 2).

The present disclosure relates in one aspect to a process for concentrating CO₂ from feed gas containing CO₂ at concentration up to 1 vol % (10,000 parts-per-million by volume (ppmv)) to produce product gas containing CO₂ at concentration that is at least twice the concentration of CO₂ in the feed gas, and wherein the concentration of CO₂ in the product gas does not exceed 20 vol %, comprising: (a) contacting the feed gas, e.g., ambient air, containing CO₂ at concentration up to 1 vol % (10,000 parts-per-million by volume (ppmv)) with sorbent on a gas-permeable media, the sorbent comprising (i) a porous support with a pore size greater than 5 nm, (ii) CO₂ adsorbing agent that is covalently bound to or otherwise incorporated onto the support, and (iii) an additive effective to enhance CO₂ adsorption, enhance CO₂ desorption, and/or lower the regeneration temperature of the sorbent, and/or enhance the thermal and/or oxidative stability of the CO₂ adsorbing agent wherein the contacting is conducted at temperature in a range of from −30° C. to 50° C., and wherein the contacting comprises flowing the feed gas through the media so that CO₂ is selectively adsorbed by the sorbent to produce CO₂-reduced gas as effluent from the contacting; (b) terminating the contacting of step (a); and (c) flowing regeneration gas, e.g., ambient air, through the media while heating the sorbent to temperature in a range of from 50° C. to 150° C. as the regeneration temperature, to desorb CO₂ from the sorbent to produce the product gas containing CO₂ at concentration that is at least twice the concentration of CO₂ in the feed gas, and wherein the concentration of CO₂ in the product gas does not exceed 20 vol %.

As used herein, “sorptively selective for CO₂” in reference to the CO₂-adsorbing sorbent of the present disclosure means that CO₂ is preferentially adsorbed as compared to other non-H₂O gas components in the CO₂-containing gas from which the CO₂ is adsorbed. Thus, the adsorbate that is adsorbed on the sorbent of the present disclosure when contacted with the CO₂-containing gas will be predominantly CO₂ and the other adsorbate components adsorbed from the CO₂-containing gas, e.g., nitrogen, oxygen, argon, etc., will be present in the adsorbate only in minor amounts. CO₂-adsorbing agents of the present disclosure may for example have CO₂/N₂, CO₂/O₂, and CO₂/argon selectivity of at least 100, and such selectivity in specific embodiments may for example be in a range of from 500 to 5000. As used herein, “additive effective to enhance CO₂ adsorption, enhance CO₂ desorption, lower regeneration temperature, and/or enhance the thermal and/or oxidative stability of the sorbent” means that the additive enhances CO₂ adsorption, enhances CO₂ desorption, lowers regeneration temperature, and/or enhance the thermal and/or oxidative stability of the sorbent, as compared to a corresponding CO₂ adsorbing sorbent lacking the additive as a constituent thereof.

### CO₂ Concentrator Module Design

As used herein, “CO₂ concentrator module” is a single process unit in a CO₂ concentrator process system, and the CO₂ concentrator process system may include one or multiple ones of such single process units, in which each single process unit (i) includes one or more structured sorbent elements, and (ii) is sized, arranged, and operated to produce at least a portion of the overall CO₂ product gas that is produced by the CO₂ concentrator process system.

As used herein, “CO₂ concentration process” is defined as a method for continuously producing a CO₂ stream containing CO₂ at concentration that is at least twice the concentration of CO₂ in the feed gas, and wherein the concentration of CO₂ in the product gas does not exceed 20 vol %, from an inlet stream of air or other gas with CO₂ concentration up to 1 vol % (10,000 ppmv), by operation of a CO₂ concentrator process system including one or more CO₂ concentrator modules that are operated with defined adsorption and desorption cycle times and sequences.

The three-dimensional structured sorbents are arranged into modules within the concentrator process to facilitate gas flow during the different phases of operation. A module can be comprised of one or more structured sorbents that are arranged in series, side-by-side, or both. When in series, the gaseous process stream passes through one structure and into the next, exiting the process downstream of the last structure in the series. Alternatively, they can be stacked and pleated. In some embodiments, the structured sorbent may be a continuous sheet that is moved through the process on a conveyor.

One or more modules are arranged into an assembly unit, which embodies the fundamental process design of the CO₂ concentrator that includes the requisite isolation mechanisms and piping for carrying out the adsorption/desorption process. Modules can be arranged in series or such that the cumulative process effluent from one module flows into another. In the preferred embodiment, modules are arranged in parallel, which allows them to undergo different operating steps (e.g., adsorption, desorption) simultaneously.

The preferred operation sequence is a 2-step process, namely adsorption and desorption steps. During adsorption step, the adsorption fluid (gas phase) containing 0-10,000 ppm CO₂ is passed over the structured sorbent in the CO₂ concentrator module for the duration of time necessary based on the target CO₂ loading and adsorption rate. The desorption step follows the adsorption step, where the structured sorbent or concentrator module is isolated from the adsorption fluid, heated to desorption temperature, and a sweep gas is used to sweep the desorbed CO₂ to the downstream process. Controlling the sorbent heating rate and/or sweep gas flow rate controls the CO₂ concentration produced from the CO₂ concentrator system.

In another embodiment, an additional purge step can be included between the adsorption and desorption steps and subsequent desorption and adsorption steps. The purge step can serve to isolate the composition of the adsorption fluid from the desorption sweeping fluid. The purge step can consist of an inert gas sweep, steam purge, vacuum purge, or a combination thereof.

During the adsorption step, the adsorption gas contacts the structured sorbent that will selectively react with CO₂. The adsorption gas can be ambient air, containing CO₂ concentrations commonly ranging from 150 to 600 ppm CO₂, building air, commonly containing of 400 to 1,500 ppm CO₂, vent from a greenhouse or other facilities commonly containing 100 to 1,500 ppm CO₂, off-gas from absorber columns, or a recycle feed from a CO₂ concentration or conversion process, or other available gas sources containing 1-10,000 ppm CO₂. Adsorptive gases can be humidified or dried before contacting the sorbent modules. The temperature and pressure of the gas can be determined by ambient air conditions at the location of the CO₂ concentrator process or by the conditions of the gas produced by an upstream process (e.g., effluent of absorber columns). For example, ambient air may be characterized by temperatures of 5° C. to 50° C. and relative humidities of 10% to 100%. In various embodiments, the relative humidity is 30% to 90% and temperatures are between 20° C. and 35° C.

The CO₂ concentrator module can operate where the structured sorbent remains stationary and switches between operation steps by action of sealing mechanism or flow driving mechanism or operates where the structure sorbent is moved from CO₂ adsorption to CO₂ desorption.

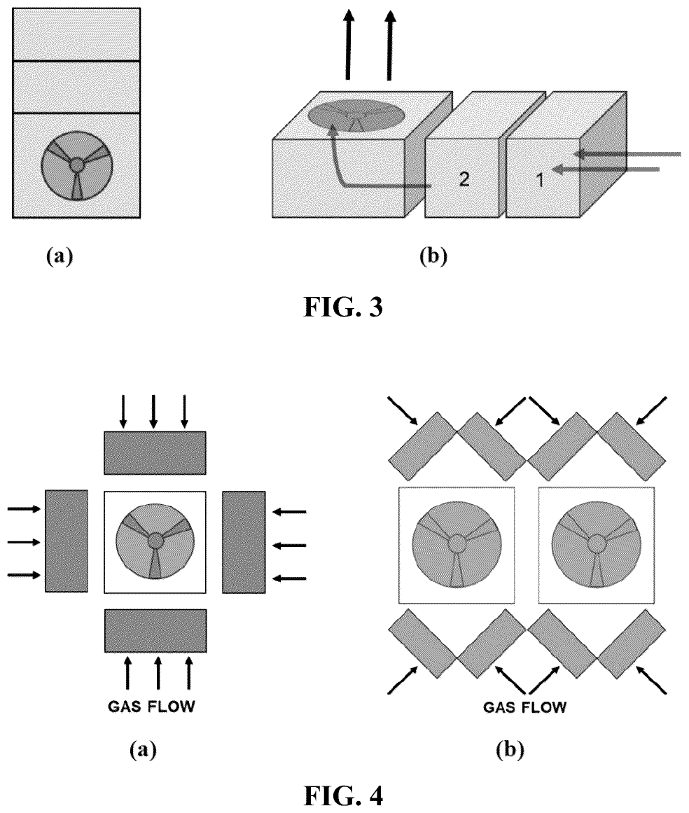

In applications where the modules are stationary, they are arranged into an assembly unit, which embodies the fundamental process design of the CO₂ concentrator that includes the requisite isolation mechanisms and piping for carrying adsorption and desorption fluids from the process. Modules can be arranged in series such that the cumulative process effluent from one module flows into another using one or more motive fluid drivers (FIG. 3). In the preferred embodiment, modules are arranged in parallel, which allows them to undergo different operating steps (e.g., adsorption, desorption) simultaneously (FIG. 4 in part (a) thereof). In embodiments with a parallel arrangement of modules, a single fluid driver may be used to facilitate gas flow for all the modules in the unit, or multiple fluid drivers may be used. A pleated module configuration may also be beneficial to reduce the land footprint required for the CO₂ concentrator modules to produce a target CO₂ production capacity. In an alternative embodiment, the modules can be in a pleated arrangement (FIG. 4 in part (b) thereof), which may reduce land area requirement for a given concentrated CO₂ production capacity.

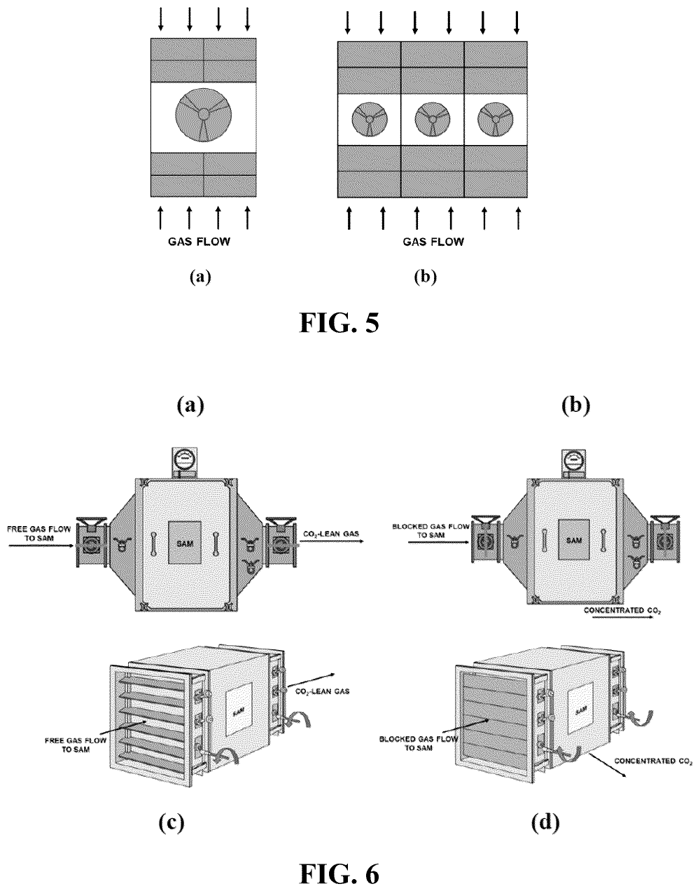

In certain embodiments, the CO₂ concentrator can be arranged in parallel and/or in series with a common induction fan for pulling gas flow through the concentrator module during the adsorption step, as illustrated in FIG. 5. Each module may undergo separate steps of CO₂ adsorption, desorption, and purge based on the target CO₂ concentration and design of the isolation and heating method.

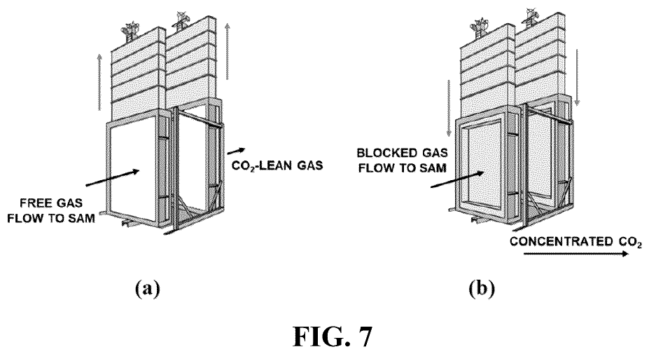

The desorption step of the operating sequence may require isolating the module and switching gas streams from the adsorption gas to the regeneration sweep gas. The isolation mechanism may consist of valves with a linear coordinate system, including knife, angle, gate, and globe valves, and sliding parallel plates that are vertically or horizontally oriented. Valves with cylindrical coordinate systems can also be used, such as rectangular and round isolation dampers and ball, butterfly, and plug valves. Examples of linear and cylindrical coordinate isolation valves incorporated into a concentrator module are illustrated in FIG. 6 and FIG. 7.

The process system may be operated to generate a continuous stream of concentrated CO₂ fluid with an average concentration in a range of from 0.1 vol % and 20 vol % CO₂, although the disclosure is not limited thereto. The process system may comprise CO₂ concentrator module(s) including structured sorbents (sorbent and substrate in a three-dimensional structure) in the desired configuration/shape. The concentrator modules can be arranged in series or in parallel. In the process system, one or more modules undergo a period of adsorption in which they are fed a CO₂-containing gas using motive fluid drivers (e.g., fans, blowers), which can be situated upstream or downstream of the modules of specific construction and operational character as adapted for the specific application. The sorbent selectively adsorbs CO₂ from the contacting adsorption fluid, and CO₂-lean gas is produced by the modules. When H₂O is also present in the adsorption fluid, water is co-adsorbed into the pores and functions as a co-reactant for the further uptake of CO₂; therefore, CO₂-lean and H₂O-lean gas is produced by the modules in such case.

At the end of the adsorption step, the modules are sealed from ambient air (e.g., with valves or dampers). Desorption (regeneration) is then performed by applying heat or intrinsically generating heat (e.g., through Joule heating) to thermally desorb CO₂ from the sorbent. The sorbent can be heated before or as the CO₂ is swept away from the sorbent and out of the module with a regeneration gas. H₂O may also be liberated from the sorbent during this step. Additional steps, such as purge steps, may take place as part of the operating sequence as needed in addition to adsorption and desorption. For example, after the adsorption step, an optional vacuum purge step may be performed by sealing the modules completely and evacuating air from the dead space. Doing so before the desorption step may further enrich CO₂ in the regeneration sweep gas to a higher concentration.

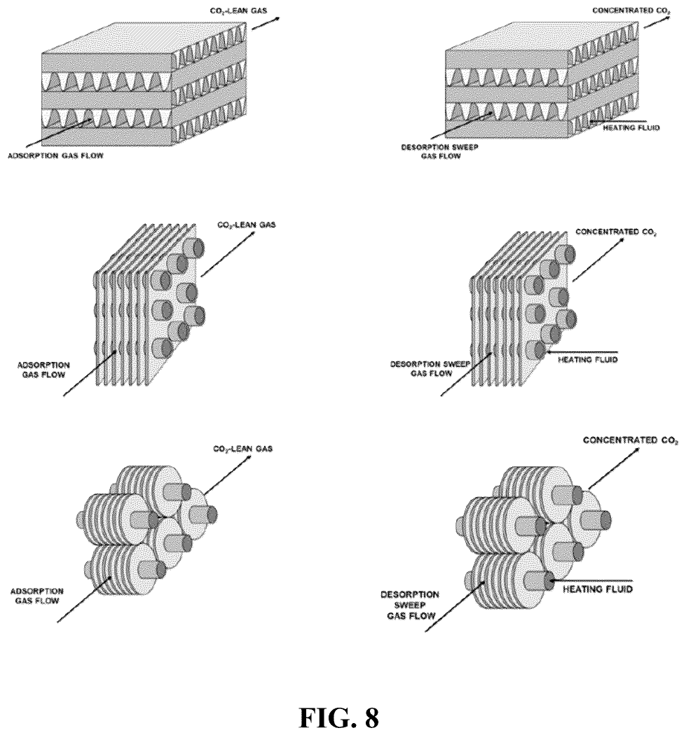

In certain embodiments, a heating fluid may be directly or indirectly used to provide thermal energy required for the desorption step. The heating fluid can be liquid or gas, with the preferred embodiment being water or steam as the heating fluid. The fluid can be in direct contact with structured sorbent provided convective and conductive heat transfer. As illustrated in FIG. 8, various configurations of indirect heat transfer between the heating fluid and the structured sorbent can be used. Two primary configurations include finned heating pipes where the structured sorbent is placed on the fins of the heating pipes or layered approach where the structured sorbent is layered between the heating fluid sections.

In general, the structured sorbent may be heated for CO₂ desorption, by any of a variety of heating modalities, such as conduction, convection, or radiative heating, or electrically resistive/Joule heating. In various embodiments, the sorbent is in contact with a heating material that is arranged for electrically resistive/Joule heating of the sorbent.

In various embodiments, any number of modules may be in any of the steps at any given time. The process system may advantageously include at least one module in the desorption step, which enables the continuous production of CO₂ at concentration up to 20 vol %, e.g., CO₂ concentration in a range of from 0.1 vol % to 20 vol % CO₂, or in other suitable range or at a specific concentration. The concentration of CO₂ in the outlet may be controlled according to several process parameters, including heating rate; vacuum purge; regeneration temperature; regeneration gas composition (e.g., humidity); sweep/regeneration gas flow rate; sorbent loading; sorbent composition (e.g., amine loading); module design (dead volume); adsorption conditions (duration, space velocity, temperature, etc.) and the number of modules undergoing desorption at a given time.

Additional gas conditioning and unit operations may be utilized downstream. For example, a unit for condensing water vapor (e.g., gas chiller with water knockout) may be used to dehumidify the effluent to a desired level. A holdup tank or other container may be installed downstream to temporarily store product gas for use in a co-located process.

To contact the structured sorbent, air or other feed gas must be moved through the system, which can be achieved through various methods. Passive contact between air or other feed gas and the sorbent modules may lower operating costs, and in such cases, the system may be optimized to facilitate air flow between or among the modules. In general, it is preferred to move the adsorptive gas mechanically to expedite capture kinetics, which are typically limited by mass transfer of dilute gaseous CO₂ to the solid sorbent surface. This is particularly relevant for CO₂ adsorption from ambient air. A pressure differential may be induced via a suitable motive fluid driver to direct ambient air or other feed gas at roughly atmospheric pressure (1 bar) through or over the modules to facilitate CO₂ capture. A mechanism for gas distribution may be installed upstream of the modules to induce a suitable pressure drop (e.g., 1 in. H₂O (1.87 mm Hg; 0.0025 bar)) for driving the adsorptive gas across the sorbent surface, and/or generation of flow turbulence. Examples of a gas distribution mechanism include a perforated plate, dense foam, plastic or metal mesh, or similar devices. Louvers or flow obstructors/baffles can be used to create turbulence for better radial gas distribution. Positive displacement of the process gas can be achieved with compressors including reciprocating, rotary screw, vane, and scroll compressors or blowers. Dynamic air movers, which include forced and induced draft fans, centrifugal fans/blowers, tangential blowers, side channel blowers, or gas ejectors could be utilized, or vacuum pumps that pull the air through the assembly could also be used in this system.

Pressure of the adsorption fluid supplied to the contacting in the process of the present disclosure may be of any suitable value or may be in any appropriate range provided by forced draft (FD) fans, induced draft (ID) fans, or other type of blowers or compressors. In various embodiments, the pressure of the feed gas supplied to the contacting in the process is such that the differential pressure across the structured sorbent is in a range of from 50 Pascal (Pa) to 5000 Pa, from 100 Pa to 2000 Pa, from 100 Pa to 1000 Pa, or in other suitable range. Pressure of the regeneration gas supplied to the gas-permeable medium in step (c) may likewise be of any appropriate value or in any appropriate range, and in various embodiments may be in a range of from 50 Pa to 5000 Pa, or in other suitable range.

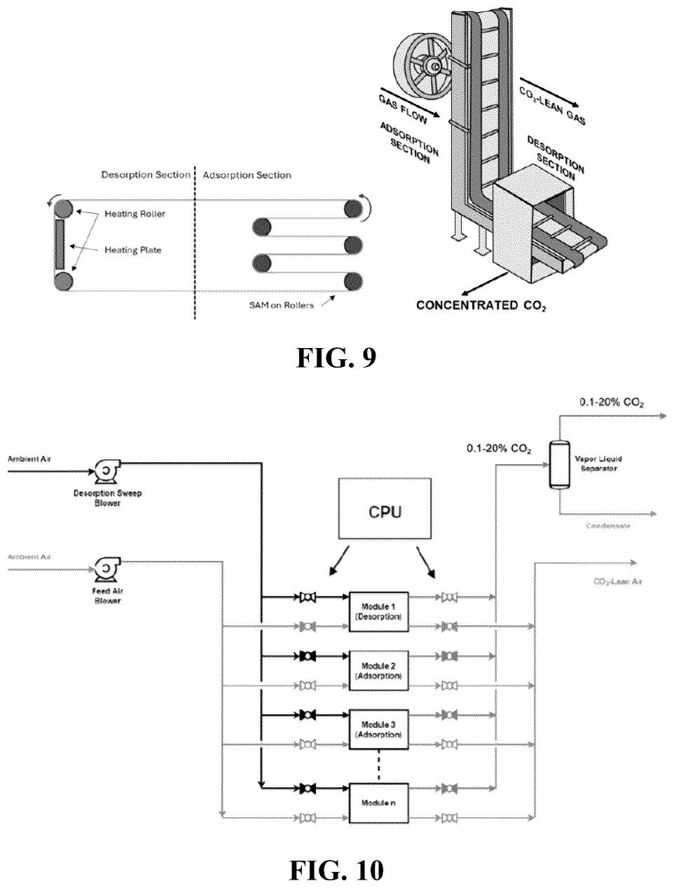

In applications in which the modules are mobile, they can move through different locations throughout the process where different process steps occur. FIG. 9 depicts a structured sorbent in the form of a continuous sheet that moves on rollers using a conveyor mechanism. In one part of the process, the structured sheet is exposed to the adsorptive gas which is mechanically driven through the structured sorbent using a fan. After sufficient residence time in the adsorption section, it is sent to a desorption section, where it is thermally regenerated using radiative heating, although it could also be regenerated via convective or conductive or Joule heating or a combination thereof. The desorption section may not rely on any seals in these cases, or they may use dynamic or static sealing mechanisms. The structured sorbent then exits the desorption section and is conveyed once again to the adsorption section where the cycle continues.

After adsorption, an optional purge step can be performed. During this step, the module is isolated from the adsorption feed source. The module can be purged with an inert gas sweep to displace/evacuate the adsorption fluid from the void spaces of the module. Alternatively, it can be evacuated via vacuum purge, which can reduce the presence of adsorption fluid in the void space within the module and ultimately increase the concentration of CO₂ during the regeneration step. Suitable vacuum pressures range from 0.9 bar to 0.001 bar. For integration with a downstream chemical process requiring CO₂, another suitable gas may be used. For example, for integrating with CO₂ hydrogenation processes, the system may be evacuated of oxygen (air) via vacuum purge and backfilled with H₂ for subsequent regeneration of CO₂ in a H₂ sweep, whereafter the H₂/CO₂ mixture is fed to a CO₂-conversion process.

In the adsorption operation, the adsorption fluid must be flowed at sufficient volumetric flowrate to achieve the desired level of CO₂ adsorption on the sorbent. In the desorption operation, the desorption sweep gas must be flowed at sufficient volumetric flowrate to achieve the desired level of CO₂ desorption and produce the product gas containing concentrated CO₂ at the desired concentration. The volumetric flow rate of the feed gas depends on the size of the CO₂ concentrator system and other factors such as the CO₂ removal efficiency, the pressure drop, and the like.

The active sorbent can be regenerated through a change in conditions including a swing in vacuum, temperature, pressure, concentration, or a combination thereof. A temperature swing can be achieved through electrical heating of structured sorbent with resistive heating properties. The structured sorbent can also be directly or indirectly convectively heated using heated gas, steam, water, or solvent to achieve regeneration. Conductive heating using a heated roller or plate or radiation, including infrared (0.7-1 mm), microwave (1 mm-1 m), or radiofrequency (>1 m) radiation, can also be used for temperature swing regeneration. In one preferred embodiment using thermal regeneration, renewable electricity is converted to thermal energy via resistive heating of the structured sorbent, and the regeneration temperature does not exceed 150° C., favoring a low regeneration temperature to reduce associated heating costs. Pressure swing can be achieved by pulling vacuum on the modules and allowing CO₂ to desorb under low pressure. Concentration swing can be achieved by reducing the partial pressure of CO₂ in the module, such as via an inert sweep (e.g., N₂), which can drive CO₂ off the sorbent surface, particularly in cases of physisorption. Combinations of these methods can be used. In certain embodiments, a vacuum pressure swing, in combination with temperature swing and an inert purge is used to desorb and recover CO₂.

FIG. 10 schematically depicts a CO₂ concentrator process system according to one aspect of the present disclosure, including a series of CO₂ concentrator modules (Module 1, Module 2, Module 3, . . . . Module n) arranged as illustrated, in which each module is (i) joined by a respective valved inlet line to a feed gas manifold supplied with adsorption fluid by a gas feed blower or other suitable motive fluid driver, and by a respective valved outlet line to a CO₂-lean air discharge manifold from which CO₂-lean air is discharged from the CO₂ concentrator process system, in the adsorption operation of the module, and in which each module also is (ii) joined by a respective valved inlet line to an ambient air sweep gas manifold supplied with ambient air by a desorption sweep gas blower or other suitable motive fluid driver, and by a respective valved outlet line to a CO₂-concentrated air discharge manifold from which it passes to a vapor/liquid separator (e.g., a knockout drum, or dehumidifier) where water is separated from the gas to produce product gas that is discharged from the system, during the desorption operation of the module, containing CO₂ at concentration that is at least twice the concentration of CO₂ in the feed gas, wherein the concentration of CO₂ in the product gas does not exceed 20 vol %.

Accordingly, the valves in the inlet and outlet lines of the respective CO₂ concentrator modules in the CO₂ concentrator process system are operated in a coordinated manner according to a cycle time program so that each CO₂ concentrator module undergoes successive adsorption and desorption operations in repeating cycles, and so that at all times of operation of the CO₂ concentrator process system, one or more of the multiple CO₂ concentrator modules of the system is carrying out the desorption operation so that the CO₂ concentrator process system carries out the CO₂ concentration process, for continuous production of product gas containing CO₂ at concentration that is at least twice the concentration of CO₂ in the feed gas, wherein the concentration of CO₂ in the product gas does not exceed 20 vol %.

It will be recognized that the term “valved” refers to any mechanism that allows for the isolation of the CO₂ concentrator modules. The isolation mechanism may consist of valves with a linear coordinate system, including knife, angle, gate, and globe valves, and sliding parallel plates that are vertically or horizontally oriented. Valves with cylindrical coordinate systems can also be used, such as rectangular and round isolation dampers and ball, butterfly, and plug valves.

It will be recognized that the CO₂ concentrator process system in various embodiments may not require a vapor/liquid separator, e.g., due to low relative humidity of the ambient air that is utilized in the system, or due to the deployment of a dehumidifier upstream of the respective ambient air blowers in the system.

The cycle time programming coordinating the respective adsorption/desorption operations of the multiple CO₂ concentrator modules in the CO₂ concentrator process system may be effected by a central processing unit (CPU) that is operationally linked to valve controllers of gas flow valves in the CO₂ concentrator process system, so that the respective inlet and outlet gas flow valves of the multiple CO₂ concentrator modules in the CO₂ concentrator process system are opened or closed by control signals transmitted by the CPU to the various valve controllers in the system according to the cycle time program resident in the CPU for such purpose. It will therefore be understood that the CPU schematically illustrated in FIG. 10 is in practice coupled in signal transmission relationship to controllers of the valves that are shown in FIG. 10, by suitable signal transmission lines, wireless communication, or other monitoring and control arrangements, and that the CPU may additionally independently modulate each of the feed air blower and desorption sweep blower of the system, as well as monitoring and controlling other process components and process variables.

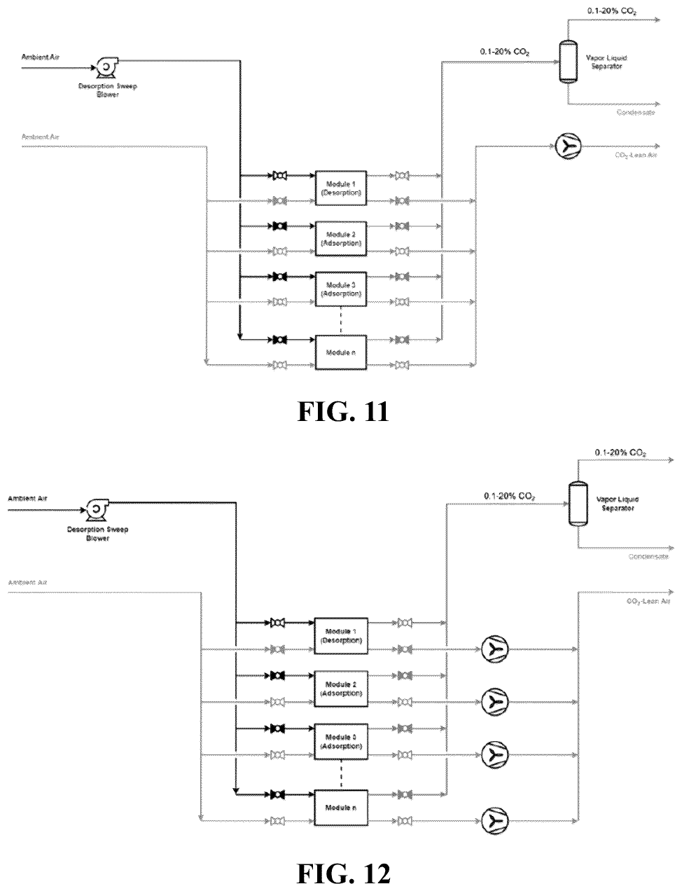

FIG. 11 schematically depicts another suitable motive fluid driver for adsorption fluid flow through the CO₂ concentrator modules, in which an induced draft fan placed on the discharge manifold continuously operates and induces air flow through multiple modules undergoing the adsorption step, so that CO₂-lean adsorption fluid is discharged from the CO₂ concentrator process system via the discharge manifold in the adsorption operation of the modules.

FIG. 12 schematically depicts another motive fluid driver arrangement in which each module has a dedicated induced draft fan that in operation induces adsorption fluid through the module when it undergoes the adsorption step, so that CO₂-lean air is discharged from the CO₂ concentrator process system via the discharge manifold in the adsorption operation of the module, with the dedicated induced draft fan turning off when the module undergoes the desorption step.

In all such configurations, each concentrator module is (i) joined by a respective valved inlet line to an adsorption fluid gas manifold supplied with adsorption fluid gas by a desorption sweep gas blower or other suitable motive fluid driver, and (ii) joined by a respective valved outlet line to a CO₂-concentrated fluid discharge manifold from which the CO₂-concentrated fluid passes to a vapor/liquid separator (e.g., a knock-out drum, or dehumidifier) where water is separated from the gas to produce product gas that is discharged from the system, during the desorption operation of the module, containing CO₂ at concentration that is at least twice the concentration of CO₂ in the feed gas, and wherein the concentration of CO₂ in the product gas does not exceed 20 vol %. As previously discussed, a vapor/liquid separator may not be required if the water or moisture content of the CO₂-concentrated air is sufficiently low.

### CO₂ Concentrator Process Integration

In various embodiments, the CO₂ concentration process of the present disclosure may be performed to provide CO₂-containing product gas to a CO₂-utilizing process system or facility, wherein the CO₂-utilizing process system or facility is selected from the group consisting of: a point source CO₂ capture process system; a membrane separation CO₂ production process system; a carbon mineralization process system; a greenhouse facility; and an aquaculture facility for algae or other aquatic plants or organisms.

Correspondingly, the present disclosure contemplates the integration of a CO₂ concentrator module or a CO₂ concentrator process system as variously described herein, with a CO₂-utilizing process system or facility, wherein the CO₂-utilizing process system or facility is selected from the group consisting of: a point source CO₂ capture process system; a membrane separation CO₂ production process system; a carbon mineralization process system; a greenhouse facility; and an aquaculture facility for algae or other aquatic plants or organisms.

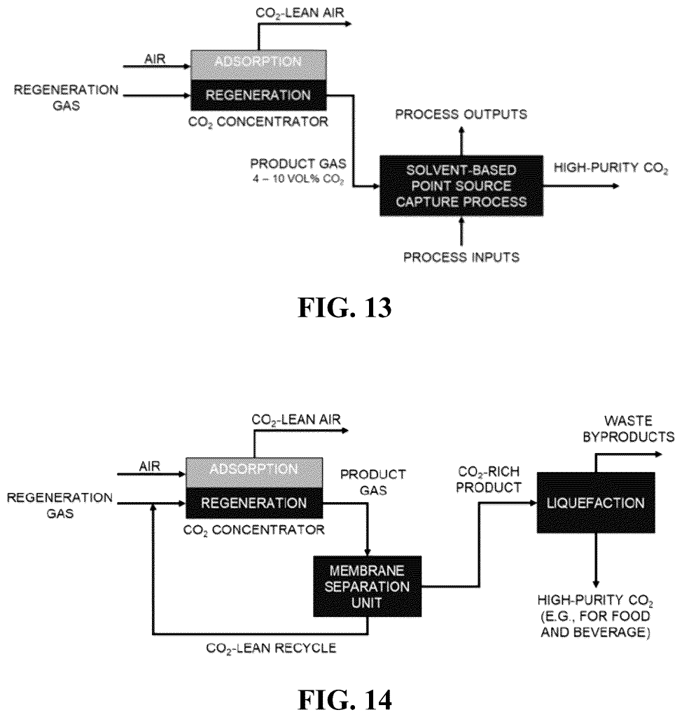

The CO₂ concentrator can be used for any application requiring concentrated CO₂ at concentration that is at least twice the concentration of CO₂ in the feed gas, and wherein the concentration of CO₂ in the product gas does not exceed 20 vol %, as a utility. In some embodiments, the concentrator is used to feed to a solvent-based point source capture system to produce >90% purity CO₂ as a product as shown in FIG. 13. These solvent-based capture processes are mature technologies that are widely deployed at industrial scales. Acceptable CO₂ concentrations include 4-20 vol %, and can be supplied to the point source solvent-based capture unit using the CO₂ concentrator. In this embodiment, the solvent-based point source capture unit will produce >90% CO₂ from the concentrated CO₂ stream supplied from the CO₂ concentrator. The coupling of the two-unit operations (CO₂ concentration to produce 4-20 vol % CO₂ and solvent capture unit producing >90% CO₂) can reduce the capital and operating cost of producing >90% CO₂ from ambient, low concentration (<10,000 ppmv) CO₂ sources compared to a single step unit operation.

In certain embodiments, the CO₂ concentrator can be integrated to an existing point source capture plant, such as one downstream of a natural gas combined cycle (NGCC) power plant. In this case, the CO₂ concentrator supplies approximately 4 vol % CO₂ to the amine-based solvent CO₂ capture system. The CO₂ concentrator can serve to maintain approximately 4 vol % CO₂ feed to the solvent capture system to buffer against fluctuating power demand, which results in fluctuating flue gas feed to the solvent-based capture system. Reducing fluctuations in flue gas feed to the solvent-based capture system can assist in maintaining overall CO₂ capture efficiency since solvent-based capture systems cannot respond quickly to changing flue gas flow rates. In this embodiment, the CO₂ concentrator may be ramped up and down to provide CO₂ to the point source capture system such that its operation is uninterrupted by the fluctuating CO₂ production of the upstream NGCC plant. In addition, the supplemental concentrated CO₂ supplied from the CO₂ concentrator system can be used to further reduce the net CO₂ emissions from a NGCC plant. The solvent-based capture system can capture greater than 90%, but less than 100% of the CO₂ from the flue gas stream. The supplemental concentrated CO₂ feed from the CO₂ concentrator is supplied from ambient air, representing net negative CO₂ emissions, and serves to offset the CO₂ that is emitted/not captured from the flue gas feed to the solvent-based capture system.

In certain embodiments, the CO₂ concentrator can be integrated with a membrane separation unit to produce >90% purity CO₂. In this case, as illustrated in FIG. 14, the CO₂ concentrator will concentrate CO₂ from an adsorption fluid containing up to 10,000 ppm CO₂, to concentration >5% CO₂, allowing the membrane separation unit to operate efficiently, and achieving a high permeate selectivity for CO₂, enabling the achievement of >90% CO₂ purity.

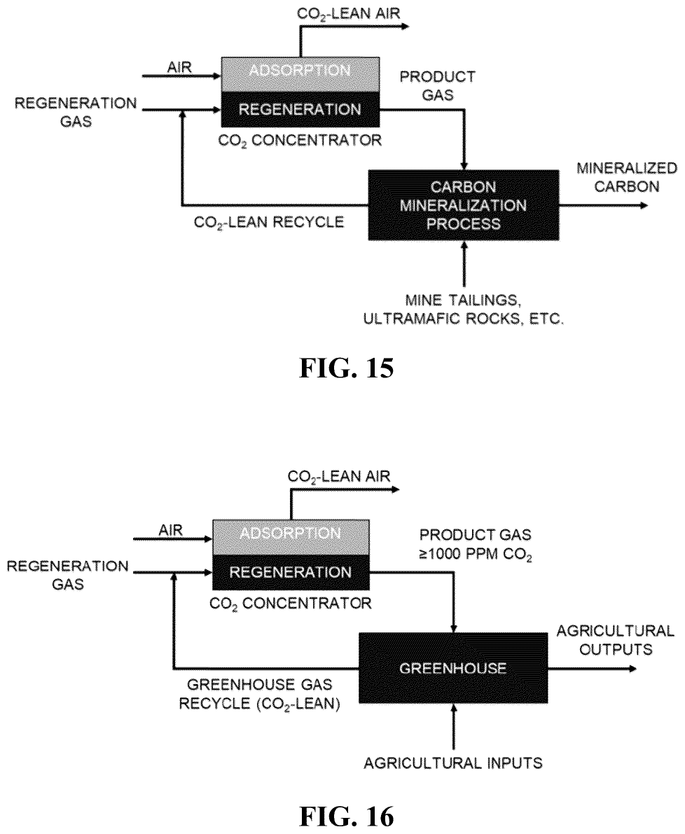

In another embodiment, the CO₂ concentrator can be integrated with a carbon mineralization process for long-term, durable carbon storage, as summarized in FIG. 15. Ultramafic rocks from the earth or industrial wastes with ultramafic character, often containing calcium and magnesium, can serve as the mineral precursor for ex-situ mineralization carried out via gas-solid carbonation or aqueous carbonation, the latter of which is preferred due to faster kinetics.

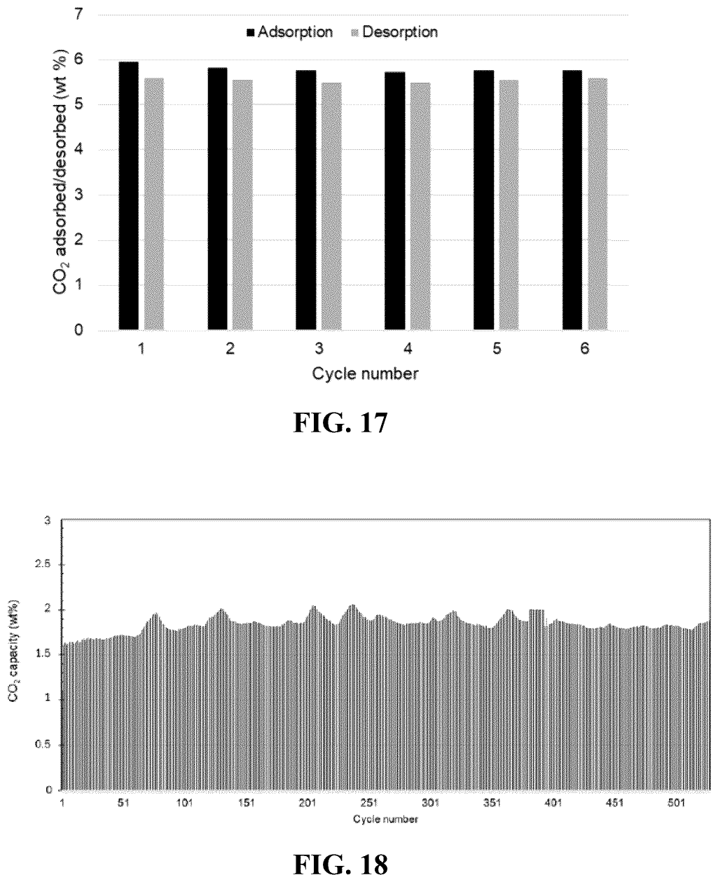

The CO₂ concentrator process may be integrated with a downstream, ex-situ mineralization process requiring <10 vol % CO₂ to facilitate mineralization reactions. In this system (FIG. 17), the regeneration gas from the concentrator process is fed into the mineralization process. Depending on the carbonation pathway, the gas may be sparged into an aqueous solution that is contacted with the solid reactants, or it may be contacted with solid reactant particles. The gaseous stream exiting the mineralization process may be recycled for use in or as the regeneration gas to further enrich the CO₂ concentration in the concentrator product stream.

In another embodiment, the CO₂ concentrator process can be integrated with a greenhouse to supply 1000 ppmv or higher of CO₂, as shown in FIG. 16. The concentrator process may include a holdup vessel to temporarily store the concentrator product, such as in cases where CO₂ uptake is slow and levels in the greenhouse are sufficient or higher than required. The system may provide a constant or varying concentration. For example, it may be configured to provide 1000 ppmv CO₂ only, or it may provide 1,200 ppmv during the day when the rate of photosynthesis is high and 1,000 ppmv at night when plants are not actively photosynthesizing with CO₂. Alternatively, the system may produce higher concentrations of CO₂ and be used to effectively dose the greenhouse atmosphere with a gas distribution system. Humidification or dehumidification of the concentrator product gas may be necessary, particularly in systems where humidity control is critical.

Commercial greenhouse farming is a means of large-scale cultivation under controlled growing conditions (e.g., temperature, lighting, air flow, and humidity) that are optimized for a particular crop. Greenhouse technology is now mature and sophisticated enough to grow crops in CO₂ as a necessary reactant in photosynthesis, the biological process in which plants assimilate CO₂ and H₂O to produce energy stored chemically as sugars and other organic compounds. Under these engineered conditions, CO₂ supplementation in greenhouse farming can be an effective way to increase plant growth, decrease the time to maturity, and increase crop yield. The benefit of CO₂ is seen with concentrations around 1,000 to 1,200 ppmv. Most commonly, CO₂ generation in greenhouses is achieved with natural gas or propane burners that are placed within the greenhouse. The disadvantage of this method is the release of toxic pollutants such as nitrogen oxides. Additionally, some greenhouses have a distribution piping network to dose pure CO₂ that has been purchased and trucked to the greenhouse site. In these cases, CO₂ is often introduced at the level of plant growth, and the system relies on diffusion to distribute CO₂ broadly throughout the greenhouse. This CO₂ concentrator technology described herein offers an alternative to these common methods of CO₂ enrichment. In this scenario, the regeneration sweep gas is directed into a co-located greenhouse using a motive fluid driver, such as a fan or blower.

In another embodiment, the CO₂ concentrator process can be integrated with enclosures and facilities to remove CO₂ generated within the enclosure/facility to maintain a desired concentration. Examples include residential and commercial buildings where the CO₂ concentrator process can be integrated with HVAC systems to remove excess CO₂ to maintain target concentration within the facility, which is generally <1000 ppmv.

In another embodiment, the CO₂ concentrator process can be integrated with algae cultivation or other aquatic plants/organisms that consume CO₂. Algae cultivation is of interest for CO₂ fixation to reduce the concentration of atmospheric CO₂, for consumption, for use in bioremediation, and for the bioproducts that algae make, which are useful in cosmetic and pharmaceutical formulations and as alternative fuels and oils. Studies have shown that increasing the concentration of CO₂ in the aeration gas during algae cultivation can increase the rate of CO₂ fixation, an effective measure of how quickly algae grow. In this embodiment, the preferred regeneration sweep gas is ambient air to generate a concentrated CO₂ stream that also contains O₂, which is cost effective and provides O₂, a requirement for cellular respiration. In this case, both the CO₂ concentration and production rate can be tuned to ensure the optimal CO₂ loading rate when aerating the algae growth medium downstream with the regeneration effluent. The pressure of the product gas may require slight pressurization to overcome the pressure drop associated with the aeration process downstream of the CO₂ concentrator.

The features and advantages of the CO₂ concentration processes of the present disclosure, and the features and advantages of the sorbent aspects of the present disclosure, will be more fully apparent from the following non-limiting examples reflecting particular embodiments and applications of the disclosure.

### EXAMPLES

### Example 1—1,2-epoxybutane Additive to Enhance Sorbent Thermal Oxidative Stability and Produce Concentrated CO₂

Twenty-five grams of wet macroporous polystyrene cross-linked with divinylbenzene and functionalized with benzylamine sorbent is placed into a clean and dry 250 mL glass beaker. Anhydrous methanol (100 mL) is added into the beaker, and the mixture is stirred with a magnetic stir bar at 200 RPM for 2 hours. The mixture is filtered, and the solids are collected in a clean, dry beaker. Another 100 mL of anhydrous methanol is added to the beaker, and the solids are washed. The wash step is repeated 4 times or until a clear solution is obtained. Then, 90 grams of anhydrous methanol are added into the beaker to constitute a suspension containing 10 wt % macroporous polystyrene cross-linked with divinylbenzene and functionalized with benzylamine sorbent in methanol. To a clean, dry beaker, 5.4218 grams of 1,2-epoxybutane (1,2 EB), an additive, are added. Over the course of three to five minutes, 1,2-EB is added dropwise into the suspension of macroporous polystyrene cross-linked with divinylbenzene and functionalized with benzylamine sorbent in methanol while it is mixed at 200 RPM. The beaker is covered and kept stirring overnight at room temperature. The suspension is filtered to collect the solids, which are then washed with 100-200 mL anhydrous methanol. The 1,2-EB-modified macroporous polystyrene cross-linked with divinylbenzene and functionalized with benzylamine sorbent is dried in an 80° C. oven for 24 hours. The final dried product is collected into a sample bottle and is labeled as EB1. The sorbent has a BET surface area of 29.27 m²/g, a pore volume of 0.22 cm³/g, and a pore size of 27.9 nm.

A 0.45-gram EB1 sample, prepared as described above, is loaded into a packed bed reactor and its equilibrium CO₂ capacity is evaluated. In this study, 867 mL (STP)/min is flowed through a water-filled impinger at room temperature and through a packed bed of 0.45 grams of sorbent for 180 minutes at 28° C. until full CO₂ breakthrough is reached. Next 867 mL (STP)/min of N₂ was flowed through a water-filled impinger at room temperature and through the sample to purge the reactor at 28° C. The temperature of the bed is raised to 80° C. until the CO₂ is desorbed from the surface. The sample is cooled in humidified N₂. This sequence constitutes one cycle. The CO₂ adsorbed in the 5-cycle experiment, in wt % of the sorbent is shown in the graph of FIG. 17, indicating that the sorbent has a CO₂ adsorption capacity of about 5.8 wt %.

The EB1 sample (0.5 grams), prepared as described above, is tested using a fast cyclic temperature swing adsorption/desorption method. Adsorption occurs for 15 minutes at 28° C. with air at 75% relative humidity (RH) and a gas hourly space velocity (GHSV) of 12,000 hr⁻¹. Following a 1-minute nitrogen purge, desorption occurs under the flow of ambient air at 75% RH ambient air (GHSV=12,000 hr⁻¹). The sample is heated at 10° C./min to 70° C. and held at 70° C. for 25 minutes. The sample is cooled to 28° C. under a flow of nitrogen for approximately 30 minutes. FIG. 18 shows the CO₂ capacity of the EB1 sorbent throughout 500 cycles performed continuously over approximately 15 days. FIG. 18 shows that there is virtually no change in CO₂ capacity over 500 fast cycles, indicating good oxidative and thermal stability of this sorbent at 70° C. in air.

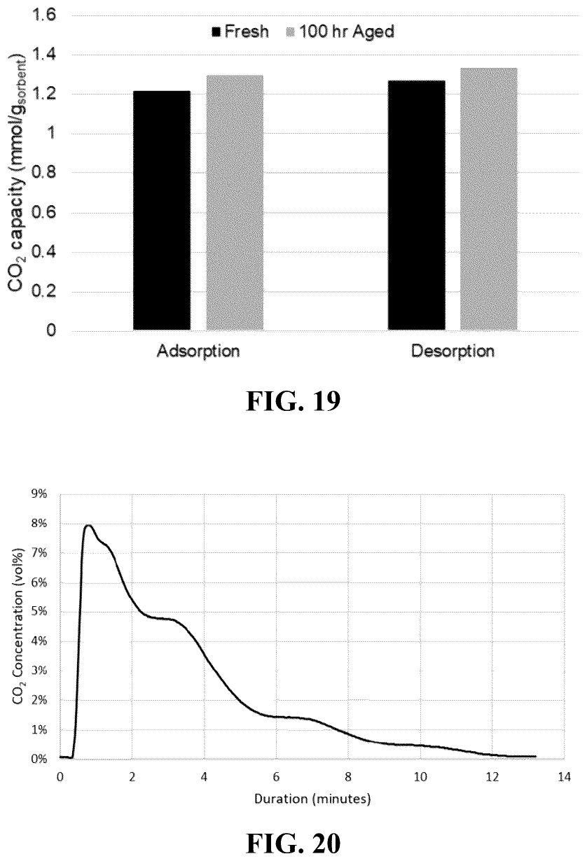

A 3.2-gram EB1 sample is aged in a tubular reactor. For 100 hours, the sample temperature is maintained at 70° C. while the sample is exposed to 200 mL (STP)/min of air flow saturated to 90% RH at about 22° C. After 100 hours, which is equivalent to about 1,500 desorption cycles, the sample is discharged, and 0.45 grams are loaded into a flow through reactor and subjected to the same equilibrium tests as described above using 70° C. desorption temperature. A comparison of fresh and aged sample performance using a 70° C. desorption temperature is given in FIG. 19. Deactivation is not observed, showing stability of the sorbent with the use of the 1,2-EB additive.

One gram of EB1 is diluted with 6 grams of silicon carbide grit and loaded into a tube with 0.75-inch outer diameter. The packed bed is heated to 80° C. under flowing nitrogen gas at 900 mL (STP)/min to completely remove any CO₂ adsorbed during storage of the material under ambient conditions. The reactor is then cooled under the flowing nitrogen. CO₂ capture was simulated at 28° C. with an air flow of 900 mL (STP)/min air containing 400 ppmv CO₂ for 160 minutes, at which point full breakthrough of CO₂ is achieved. The air flow is stopped, and the sample is heated to 80° C. in stagnant air before flowing 0.075 L (STP)/min of air through the bed to sweep desorbed CO₂ away from the sorbent bed and to a non-dispersive infrared (NDIR) CO₂ analyzer downstream. FIG. 20 shows the concentration of CO₂ as a function of time. It shows the initial period when the concentration is nearly 0%, which corresponds to the heating of the sorbent bed in stagnant air. The rapid increase in concentration thereafter corresponds to the initiation of 0.075 L (STP)/min air that sweeps CO₂ from the bed. The CO₂ concentration reaches a maximum value of nearly 8% before CO₂ is depleted from the sorbent and the concentration trends to 0%.

### Example 7

The CO₂ adsorbing agent can be prepared through a multi-step reaction by synthesizing a macroporous chloromethylated polystyrene polymer. To achieve a macroporous chloromethylated polystyrene polymer, macroporous divinylbenzene crosslinked polystyrene beads are swelled in a solution containing 1.5 to 5 mass equivalents chloromethyl ether solution and 0.3 to 0.7 mass equivalents of a transition metal catalyst, which could be one or more of anhydrous tin chloride, anhydrous zinc chloride, anhydrous aluminum chloride and/or anhydrous ferric chloride. While stirring, sulfuric acid is then added dropwise to the suspension at 30° C.-45° C. The reaction is allowed to stir for ten hours followed by filtration of the beads from the solvent. In some embodiments, the catalyst can be one or more of anhydrous tin chloride, anhydrous zinc chloride, anhydrous aluminum chloride and/or anhydrous ferric chloride. The CO₂ capture agent can be attached to the support by stirring in 1.5 to 5 mass equivalents of an amine, including a primary, secondary or tertiary amine or any mixtures thereof, at 48° C. to 53° C. for 12 hours. The amine-substituted beads are isolated and dried. The dried microspheres form of the sorbent is used to concentrate CO₂ from ambient air to a concentration that is at least twice the concentration of CO₂ in the ambient air, and wherein the concentration of CO₂ in the product gas does not exceed 20 vol %.

### INDUSTRIAL UTILITY

The CO₂ concentration processes, CO₂ concentrators, and related materials and systems of the present disclosure are useful to concentrate CO₂ from gases containing CO₂ at concentrations up to 1 vol % (10,000 parts-per-million by volume (ppmv)) to produce product gas containing CO₂ at concentration that is at least twice the concentration of CO₂ in the feed gas, and wherein the concentration of CO₂ in the product gas does not exceed 20 vol %. Such processes, devices, materials, and systems correspondingly enable production of CO₂-containing product gas that is usefully employed for a variety of industrial applications, including for example food and beverage applications, greenhouse and agricultural applications, enhanced oil recovery, cement curing, algae cultivation, and CO₂ mineralization.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

What is claimed is:

1. A CO₂ sorbent composition, comprising (i) a porous support, e.g., a mesoporous and macroporous polymer backbone with a pore size greater than 5 nm, (ii) CO₂ adsorbing agent that is covalently bound to or otherwise attached to the porous support, and (iii) an additive effective to enhance CO₂ adsorption, enhance CO₂ desorption, lower the regeneration temperature of the sorbent, and/or enhance the thermal and/or oxidative stability of the sorbent.

2. The CO₂ sorbent composition of claim 1, wherein the porous support comprises a polymer selected from the group consisting of polystyrene (PS), polyvinylidene fluoride (PVDF), polyacrylonitrile (PAN), polytetrafluoroethylene (PTFE), polypropylene (PP), polyethylene (PE), polyvinylchloride (PVC), polydimethylsiloxane (PDMS), polyacrylates, polyesters, polyurethanes, polyimides, polysilanes, polysulfides, polythiazyls, polysiloxanes, and polyphosphazenes.

3. The CO₂ sorbent composition of claim 1, wherein the CO₂ adsorbing agent comprises an amine of the formula R₁R₂NR₃, wherein R₁, R₂, and R₃ are independently hydrogen, alkyl, alkenyl, aminoalkyl, aminoalkanol, cycloalkyl, aryl, or other hydrocarbyl.

4. The CO₂ sorbent composition of claim 1, wherein the CO₂ adsorbing agent is immobilized on the support at a loading of 0.5 to 35 wt % of nitrogen, based on weight of the support.

5. The CO₂ sorbent composition of claim 1, wherein the CO₂ adsorbing agent comprises an amine of the formula R₁—NH₂, R₁NHR₂, or R₁NR₂R₃, where R₁, R₂ and R₃ are each independently alkyl, alkenyl, aminoalkyl, aminoalkanol, cycloalkyl, aryl, or other hydrocarbyl.

6. The CO₂ sorbent composition of claim 1, wherein the CO₂ adsorbing agent comprises at least one selected from the group consisting of poly(ethyleneimine), poly(propylenimine), poly(allylamine), tetraethylenepentamine, monoethanolamine, benzylamine, triethanolamine, dimethanolamine, diethylenetriamine, 2-2 (-aminoethylamino) ethanol, diisopropanolamine, 2-amino-2-methyl-1,3-propanediol, pentaethylenehexamine, tetramethylenepentaamine, methyldiethanolamine, aminomethyl propanol piperazine and piperazine derivatives, piperidine and piperidine derivatives, and pyrrolidine and pyrrolidine derivatives.

7. The CO₂ sorbent composition of claim 1, wherein the CO₂ adsorbing agent comprises an amino acid or an amino acid salt.

8. The CO₂ sorbent composition of claim 1, wherein the additive comprises an alkali carbonate salt.

9. The CO₂ sorbent composition of claim 1, wherein the additive comprises a compound of the formula R₁R₂N—R₃—COOH, wherein each of R₁, R₂ and R₃ is independently selected from H, C₁-C₁₂ alkyl, C₁-C₁₂ alkoxy, C₁-C₁₂ carboxy, C₁-C₁₂ haloalkyl, C₆-C₁₂ aryl, C₆-C₁₄ arylalkyl, C₅-C₁₀ cycloalkyl, amino, substituted amino, thiol, phosphate, sulfate, phosphonate, and sulfonate.

10. The CO₂ sorbent composition of claim 1, wherein the additive comprises an amino acid.

11. The CO₂ sorbent composition of claim 1, wherein the additive comprises at least one selected from the group consisting of alkyl-epoxy, glycidol and its derivatives, and 1,2-epoxy-2-methylpropane.

12. The CO₂ sorbent composition of claim 11, wherein the alkyl-epoxy comprises epoxybutane or epoxypropane.

13. The CO₂ sorbent composition of claim 1, wherein the additive comprises:
(i) at least one selected the group consisting of ammonium ([R₁R₂NR₃R₄]⁺) and alkali phosphate salts, wherein R₁, R₂, R₃ and R₄ are independently hydrogen, alkyl, alkenyl, aminoalkyl, aminoalkanol, cycloalkyl, aryl, or other hydrocarbyl; or
(ii) trisodium phosphate, lithium phosphate, tetraethyl ammonium phosphate, or tetramethylammonium phosphate; or
(iii) a compound selected the group consisting of polyethylene glycol, hydroxyethylene starch, cellulose, polyvinyl alcohol, 2,6-di-tert-butyl-p-cresol, (4-(1-methyl-1-phylethyl)N-[4-(1-methyl-1-phenylethyl)phenyl] alanine), and 2-mercaptobenzimidazole.

14. The CO₂ sorbent composition of claim 1, of a spherical particulate form, with a particle size in a range from 0.01 mm to 5.0 mm, a pore size of porosity in a range of from 5 nm to 500 nm, a pore volume of sorbent particles in a range of from 0.1 cm³/gram to 3 cm³/gram, and a BET surface area in a range of 10 m²/gram to 500 m²/gram.

15. The CO₂ sorbent composition of claim 1, comprising benzylamine substituted macroporous polystyrene beads, modified with 0.5 molar equivalents of 1,2-epoxybutane additive.

16. A process for concentrating CO₂ from feed gas containing CO₂ at concentration up to 1 vol % (1000 parts-per-million by volume (ppmv)) to produce product gas containing CO₂ at concentration that is at least twice the concentration of CO₂ in the feed gas, and wherein the concentration of CO₂ in the product gas does not exceed 20 vol %, comprising:
(a) contacting the feed gas containing CO₂ at concentration up to 1 vol % (1000 parts-per-million by volume (ppmv)) with sorbent on a gas-permeable media, the sorbent comprising (i) a porous polymer support with a pore size greater than 5 nm, (ii) CO₂ adsorbing agent that is covalently bound to or otherwise attached to the support, and (iii) an additive effective to enhance CO₂ adsorption, enhance CO₂ desorption, lower the regeneration temperature of the sorbent, and/or enhance the thermal and/or oxidative stability of the sorbent, wherein the contacting is conducted at temperature that is in a range of from −30° C. to 50° C., and wherein the contacting comprises flowing the feed gas through the media so that CO₂ is selectively adsorbed by the sorbent to produce CO₂-reduced gas as effluent from the contacting;
(b) terminating the contacting of step (a); and
(c) flowing regeneration gas through the media while heating the sorbent to temperature in a range of from 50° C. to 150° C. as the regeneration temperature, to desorb CO₂ from the sorbent to produce the product gas containing CO₂ at concentration that is at least twice the concentration of CO₂ in the feed gas, and wherein the concentration of CO₂ in the product gas does not exceed 20 vol %.

17. A CO₂ concentrator module, comprising sorbent comprising (i) a porous support with a pore size greater than 5 nm, (ii) CO₂ adsorbing agent that is covalently bound to or otherwise attached to the porous support, and (iii) an additive effective to enhance CO₂ adsorption, enhance CO₂ desorption, lower regeneration temperature of the sorbent, and/or enhance the thermal and/or oxidative stability of the sorbent, wherein the sorbent is comprised in multiple structured sorbent elements.

18. A CO₂ concentrator process system comprising multiple ones of the CO₂ concentrator module of claim 17, as integrated with a CO₂-utilizing process system or facility, wherein the CO₂ concentrator process system is constructed and arranged to provide concentrated CO₂ gas to the CO₂-utilizing process system or facility, and wherein the CO₂-utilizing process system or facility is selected from the group consisting of: a point source CO₂ capture process system; a membrane separation CO₂ production process system; a carbon mineralization process system; a greenhouse facility; and an aquaculture facility for algae or other aquatic plants or organisms.

19. A process according to claim 16, as performed to provide CO₂-containing product gas to a CO₂-utilizing process system or facility, wherein the CO₂-utilizing process system or facility is selected from the group consisting of: a point source CO₂ capture process system; a membrane separation CO₂ production process system; a carbon mineralization process system; a greenhouse facility; and an aquaculture facility for algae or other aquatic plants or organisms.

20. A process according to claim 16, as performed to provide CO₂-containing product gas to a CO₂-utilizing process system or facility, wherein the CO₂-utilizing process system or facility produces an effluent gas, and the effluent gas is recirculated to constitute at least part of the regeneration gas in the process.
